(19) United States
(12) Patent Application Publication
(10) Pub. No.: US 2003/0078056 A1
(43) Pub. Date: Apr. 24, 2003

(54) Communication system and line selecting method

(76) Inventors: Sunao Takatori, Tokyo (JP); Hisanori Kiyomatsu, Tokyo (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/257,646

(22) PCT Filed: Jul. 19, 2001
(86) PCT No.: PCT/JP01/06261

(30) Foreign Application Priority Data
Apr. 18, 2001 (JP) 2001-120143

(51) Int. Cl. H04Q 7/20

(52) U.S. Cl. 455/456

(57) ABSTRACT

A mobile communication terminal (101 to 10N) can obtain a plurality of communication services MS1 to MSn and sends an identification code unique to itself when making an outgoing call. Databases DB1 to DBn are provided for the plurality of mobile communication terminals MS1 to MSn, and when the mobile communication terminal (101 to 10N) makes an outgoing call, they acquire the unique identification code for specifying the mobile communication terminal (101 to 10N), and store billing information on the mobile communication terminal (101 to 10N) in association with the identification code. A billing server TDB classifies the billing information stored in all of the databases DB1 to DBn by each mobile communication terminal (101 to 10N) based on the identification code to generate billing information on each user.

### TECHNICAL FIELD

The present invention relates to a communication terminal such as a mobile terminal, a fixed telephone, or a line selecting device, a billing server for managing information on fees of each customer, a communication system using the communication terminal, the billing server, and the like, and a line selecting method in the communication system.

### BACKGROUND ART

Currently, many mobile communication services are provided, and the selection of the optimum service according to intended use and use area is highly demanded. In response to this demand, a mobile communication terminal adapting to a plurality of mobile communication services, for example, both of PDC (Personal Digital Cellular) and PHS (Personal Handyphone System) is on sale.

Moreover, hitherto, in a fixed telephone, plural telephone communication services provided by plural carriers can be used, and when a call is made after the addition of a number for specifying a telephone communication service to be used to the head of the other party's telephone number, telephone communication is executed by the telephone communication service specified by the number. On the other hand, when a number for specifying a telephone communication service is not added, telephone communication is executed by a telephone communication service registered in advance. Under such circumstances where plural telephone communication services compete with each other, an LCR (Least Cost Routing) function of automatically selecting a telephone communication service with the lowest communication fee based on the other party's telephone number, that is, auto select function of a line with the lowest fee is put into practical use.

However, there is a problem that even if a mobile communication terminal can use plural mobile communication services, it is necessary for its user to select a mobile communication service to be used, and its operation is complicated.

Moreover, fee systems of respective mobile communication services are not uniform, and hence it is not easy to find the optimum mobile communication service in each case.

Furthermore, there is a strong tendency that a specific type II carrier adds the LCR function in a mobile communication service so that its own telephone communication service is used, and therefore, the most inexpensive telephone communication service is not always selected for any of users. For example, a mobile communication service is not necessarily selected in consideration of fee systems of respective services contracted by the user. Besides, the LCR function is intended for only telephone communication services as its precondition.

The present invention is made in view of the aforesaid problems, and its object is to obtain a communication terminal, a billing server, a communication system, and a line selecting method which make it possible to select a line with a lower usage fee.

### DISCLOSURE OF THE INVENTION

A mobile communication terminal of the present invention comprises: a storage part in which information on business areas of and communication fees for respective mobile communication lines is stored; a location information acquiring part for acquiring its own current location information; and a line selecting part for selecting the most inexpensive mobile communication line out of mobile communication lines whose business areas cover a current location shown by the location information acquiring part, based on the information on business areas of and communication fees for the respective mobile communication lines stored in the storage part.

Consequently, a line with a lower usage fee can be selected.

Moreover, in a mobile communication terminal of the present invention, in addition to the mobile communication terminal of the aforementioned invention, a receive-only mobile communication line is further assigned thereto, and the location information acquiring part acquires its own current location information, based on the receive-only mobile communication line.

Hence, the reception of an incoming call can be certainly realized.

Furthermore, in a mobile communication terminal of the present invention, in addition to the mobile communication terminals of the aforementioned respective inventions, the location information acquiring part acquires its own current location information based on a GPS signal.

Thereby, location registration can be always performed without using the receive-only mobile communication service.

Furthermore, in a mobile communication terminal of the present invention, in addition to the mobile communication terminals of the aforementioned respective inventions, a communication line of a pager is further assigned thereto, and the location information acquiring part acquires its own current location information based on the communication line of the pager.

As a result, location registration can be performed at the stage of reception of an incoming call, whereby a power-saving and inexpensive system can be realized.

Moreover, in addition to the mobile communication terminals of the aforementioned respective inventions, a mobile communication terminal of the present invention comprises a plurality of baseband processing parts for performing separate communications in parallel.

Consequently, separate communications can be performed in parallel by the plurality of baseband processing parts.

A line selecting device of the present invention comprises: a communication means capable of using plural types of communication lines; a storage means in which information on communication fees for respective communication lines is stored; and a selection means for selecting the most inexpensive communication line according to a communication mode to be used, based on the information on communication fees stored in the storage means.

Accordingly, a line with a lower usage fee can be selected.

Further, in a line selecting device of the present invention, in addition to the line selecting device of the aforementioned invention, the selection means selects the most inexpensive communication line according to the communication mode to be used and the type of the other party's communication device, based on the information on communication fees stored in the storage means.

Thereby, even when used communication modes mingle, a line with a lower usage fee can be selected for each of the communication modes.

Moreover, in addition to the line selecting devices of the aforementioned respective inventions, a line selecting device of the present invention comprises an individual fee data receiving means for receiving the information on communication fees for a user of this line selecting device sent from a billing server which manages information on users of line selecting devices, and the storage means stores the information on communication fees received by the individual fee data receiving means.

Therefore, a line with a lower usage fee can be always selected for each user based on the individual fee data which is sent appropriately.

Further, in addition to the line selecting devices of the aforementioned respective inventions, a line selecting device of the present invention comprises a line switching means for, when a communication line is already established, switching the communication line being used for communication to another communication line according to a communication information amount.

Accordingly, even during communication, it is possible to use a more inexpensive line and hence reduce a line usage fee.

Furthermore, in addition to the line selecting devices of the aforementioned respective inventions, a line selecting device of the present invention comprises a communication information amount estimating means for estimating, depending on operation by a user, the communication information amount occurred as the result of the operation.

Consequently, it is possible to switch the communication line into a communication line consistent with the communication information amount, resulting in a further reduction in line usage fee.

A communication terminal of the present invention comprises: a communication means capable of using plural types of communication lines; a storage means in which information on communication fees for respective communication lines is stored; a selection means for selecting the most inexpensive communication line according to a communication mode to be used, based on the information on communication fees stored in the storage means; and a control means for, at the start of communication, controlling the selection means so that a communication line is selected and controlling the communication means so that the communication line is selectively established.

Thereby, a line with a lower usage fee can be selected.

A billing server of the present invention comprises: a first storage means for storing information indicating types of respective communication services used by each of users with respect to each user; a second storage means for storing fee information on a plurality of communication services; an individual fee data generating means for unifying fee information on one or plural communication services used by each of the users to generate individual fee data with respect to each user, based on the information indicating the types of the respective communication services used by each of the users and the fee information on the respective communication services; and a sending means for sending the individual fee data for the user to a communication terminal of the user.

As a result, the individual fee data generated for each user based on the fee information on the respective communication services is delivered to the communication terminal or the like of the user, whereby a line with a lower usage fee can be selected.

Moreover, in addition to the billing server of the aforementioned invention, a billing server of the present invention comprises a third storage means for storing information indicating types of fee systems contracted by the users regarding respective communication services used by the users, and the individual fee data generating means for referring to fee information from the respective communication services and regarding one or plural communication services used by each of the users, and for unifying fee information on the fee systems contracted by the user concerning the respective communication services to generate the individual fee data with respect to each user.

Thereby, it becomes possible for a communication terminal to select a line with a lower usage fee in consideration of the fee systems contracted by the user.

Moreover, in addition to the billing servers of the aforementioned inventions, a billing server of the present invention comprises a receiving means for receiving the fee information on the plurality of communication services.

As a result, it is possible to generate the individual fee data based on the fee information sent from the communication services and reflect the fee information on the communication services in the individual fee data correctly and promptly.

A mobile communication system of the present invention comprises: a mobile communication terminal which is allowed to obtain a plurality of mobile communication services and sends an identification code unique to itself when making an outgoing call; a plurality of control servers which are provided for the plurality of mobile communication services, when the mobile communication terminal makes the outgoing call, acquires the unique identification code for specifying the mobile communication terminal, and stores billing information on the mobile communication terminal in association with the identification code; and a billing server which classifies the billing information stored in all of the control servers by each mobile communication terminal based on the identification code and generates billing information on each user.

Accordingly, it becomes possible that the mobile communication terminal selects a line with a lower usage fee.

Moreover, in a mobile communication system of the present invention, in addition to the mobile communication system of the aforementioned invention, the mobile communication terminal performs location registration by a receive-only mobile communication line and receives an incoming call by this receive-only mobile communication line by which the location registration is performed.

Thereby, the reception of an incoming call by the mobile communication terminal can be certainly realized.

Further, in a mobile communication system of the present invention, in addition to the mobile communication systems of the aforementioned respective inventions, the mobile communication terminal performs location registration based on a GPS signal.

Consequently, the mobile communication terminal can always perform location registration without using the receive-only mobile communication service.

Furthermore, in a mobile communication system of the present invention, in addition to the mobile communication systems of the aforementioned respective inventions, the mobile communication terminal is adaptable to a communication line of a pager, and the billing server sends a signal for allowing location registration to be performed to the mobile communication terminal via the communication line of the pager.

As a result, the mobile communication terminal can perform location registration at the stage of reception of an incoming call, whereby a power-saving and inexpensive system can be realized.

A communication system of the present invention comprises: a communication terminal including a communication means capable of using plural types of communication lines, a storage means in which information on communication fees for respective communication lines is stored, and a selection means for selecting the most inexpensive communication line according to a communication mode to be used, based on the information on communication fees stored in the storage means; and a billing server including a first storage means for storing information indicating types of respective communication services used by each of users with respect to each user, a second storage means for storing fee information on a plurality of communication services, an individual fee data generating means for unifying fee information on one or plural communication services used by each of the users to generate individual fee data with respect to each user, based on the information indicating the types of the respective communication services used by each of the users and the fee information on the respective communication services, and a sending means for sending the individual fee data for the user as the information on communication fees to a communication terminal of the user.

Thereby, it becomes possible that the communication terminal selects a line with a lower usage fee.

A line selecting method of the present invention comprises the steps of: extracting fee information on communication services used by each of users from fee information on a plurality of communication services and unifying it to generate individual fee data; sending the generated individual fee data to a communication terminal of the user; receiving the individual fee data by the communication terminal of the user; and selecting the most inexpensive communication line according to a communication mode to be used, based on the received individual fee data by the communication terminal of the user.

Therefore, it becomes possible that the user's terminal device selects a line with a lower usage fee.

A control program of the present invention makes a mobile communication terminal function as: a location information acquiring part for acquiring its own current location information; and a line selecting part for selecting, based on information on business areas of and communication fees for respective mobile communication lines, a mobile communication line which is not used by the other mobile communication terminals and is the most inexpensive out of mobile communication lines whose business areas cover a current location shown by the location information acquiring part.

This makes it possible that a mobile communication terminal which executes this control program selects a line with a lower usage fee.

A control program of the present invention makes electronic equipment function as: a communication means capable of using plural types of communication lines; a storage means in which information on communication fees for respective communication lines is stored; and a selection means for selecting the most inexpensive communication line according to a communication mode to be used, based on the information on communication fees stored in the storage means.

This makes it possible that electronic equipment which executes this control program selects a line with a lower usage fee.

### BRIEF DESCRIPTION OF DRAWINGS

FIG. 1 is a block diagram showing the configuration of a mobile communication system according to an embodiment 1 of the present invention;

FIG. 2 is a block diagram showing the configuration of another mobile communication system according to the embodiment 1 of the present invention;

FIG. 3 is a block diagram showing the configuration of a mobile communication terminal in FIG. 1;

FIG. 4 is a flowchart explaining the operation of the mobile communication terminal shown in FIG. 3;

FIG. 5 is a block diagram showing the configuration of a mobile communication terminal according to an embodiment 2 of the present invention;

FIG. 6 is a block diagram showing the configuration of a mobile communication system according to an embodiment 3 of the present invention;

FIG. 7 is a block diagram showing a communication situation of one mobile communication terminal in the embodiment 3;

FIG. 8 is a block diagram showing the configuration of a communication system according to an embodiment 4 of the present invention;

FIG. 9 is a block diagram showing the configuration of a communication terminal in FIG. 8;

FIG. 10 is a block diagram showing the configuration of a communication system according to an embodiment 5 of the present invention; and

FIG. 11 is a block diagram showing the configuration of a line selecting device in FIG. 10.

### BEST MODE FOR CARRYING OUT THE INVENTION

Embodiments of the present invention will be explained below based on the drawings.

Embodiment 1.

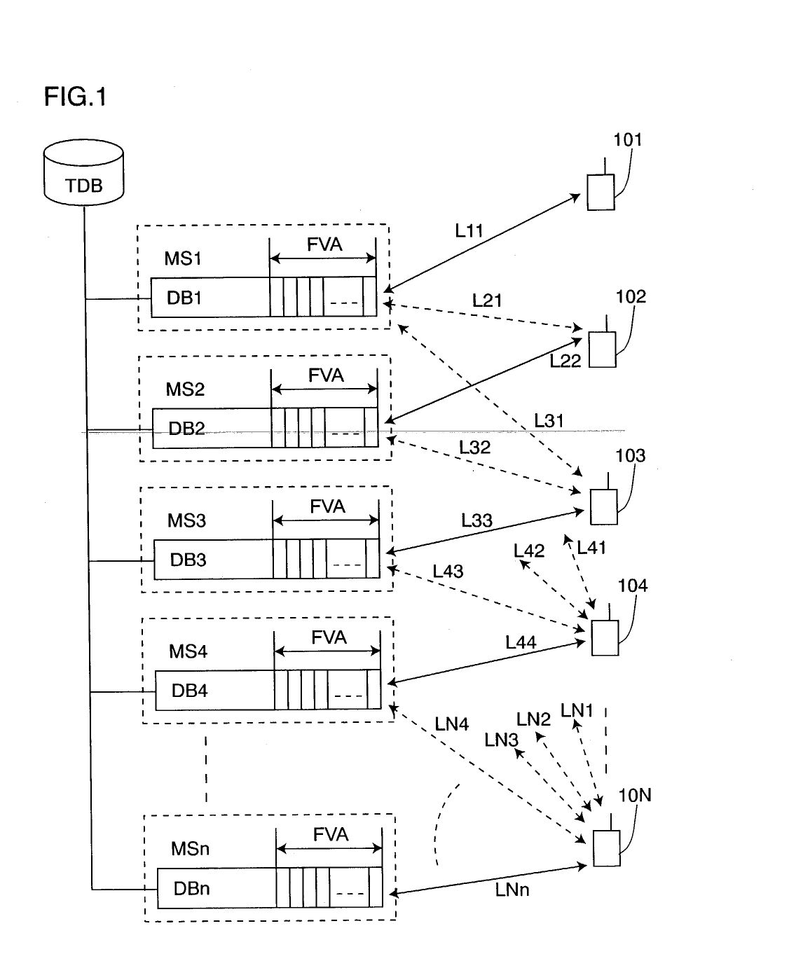

FIG. 1 is a block diagram showing the configuration of a mobile communication system according to the embodiment 1 of the present invention.

This mobile communication system includes plural mobile communication terminals 101, 102, . . . , 10N adapting to plural mobile communication services MS1, MS2, . . . , MSn, and plural common line numbers of the mobile communication services MS1 to MSn are assigned to the plural mobile communication terminals 10i, . . . .

Namely, each mobile communication service MSj (1≦j≦n) assigns a smaller number of lines than a total number K of the contracted mobile communication terminals 10i to the contracted mobile communication terminals 10i. Meanwhile, each of the mobile communication terminals 10i can use a line which is not used by the other mobile communication terminals 10i to which the same line numbers are assigned out of lines provided by the plural mobile communication services MSj with which it is under contract.

As an example, a case where there are three mobile communication services MS1 to MS3 and 150 mobile communication terminals 101 to 10150 will be explained. On this occasion, supposing that the mobile communication terminals 101 to 1050 are under contract with the mobile communication services MS1 and MS2, the mobile communication terminals 1051 to 10100 are under contract with the mobile communication services MS2 and MS3, and the mobile communication terminals 10101 to 10150 are under contract with the mobile communication services MS1 and MS3, the mobile communication service MS1 assigns, for example, 50 line numbers to 100 mobile communication terminals 101 to 1050 and 10101 to 10150, the mobile communication service MS2 assigns, for example, 50 line numbers to 100 mobile communication terminals 101 to 1050 and 1051 to 10100, and the mobile communication service MS3 assigns, for example, 50 line numbers to 100 mobile communication terminals 1051 to 10100 and 10101 to 10150.

It should be noted that this example is for explanation, and the number of the mobile communication services MSj, the number of the mobile communication terminals 10i, and the number of the respective line numbers are not limited to the aforementioned numbers. Moreover, concerning the assignment of the line numbers, in place of collective assignment of 50 lines to 100 mobile communication terminals 10i, for example, the mobile communication terminals 10i may be divided into groups of 10 mobile communication terminals 10i, and five lines may be assigned to each of the groups. Of course, assignment methods other than this may be adopted.

The mobile communication services MS1 to MSn comprise databases DB1 to DBn each including VCR (Visitor Location Register) for registering users' location information, HLR (Home Location Register) for registering users' billing information, or the like, respectively.

Namely, these databases DB1 to DBn are provided in relation to the plural mobile communication services MS1 to MSn, and function each as a control server which, when an outgoing call is made by one of the mobile communication terminals 10i, acquires a unique identification code for specifying the mobile communication terminal 10i and stores billing information on the mobile communication terminal in association with the identification code.

Each database DBj (1≦j≦n) is provided with a contract line area FVA for the mobile communication terminals 10i, . . . of one or plural users who are under contract with the mobile communication service MSj having this database DBj. Information on the registered mobile communication terminals 10i, . . . is registered at the contract line area FVA for each contract line number. Accordingly, plural common line numbers are assigned to plural mobile communication terminals 10i, . . . .

Thus, even if a total number N of the mobile communication terminals 101 to 10N is large, the capacity of this FVA is small, and its maintenance is easy. Moreover, a contract fee for use of each mobile communication service MSj can be made lower.

Furthermore, the mobile communication system according to the embodiment 1 is provided with a billing server TDB common to all of the mobile communication services MS1 to MSn. Status of a contract with the mobile communication services of each user, each user's ID information, availability authentication, a line usage fee when each mobile communication service is used, and so on are registered at this billing server TDB.

Next, the operation of the aforementioned mobile communication system will be explained.

Firstly, operation at the time of selecting a line will be explained. Incidentally, to simplify the explanation, a case where each one line number is assigned to plural mobile communication terminals 10i will be explained.

When, out of the mobile communication terminals 101 to 10N, m mobile communication terminals 101 to 10m to which one line number is assigned in common intend to make an outgoing call, each mobile communication terminal 10i (1≦i≦m) selects a service with the lowest usage fee (for example, the mobile communication service MS1) out of the contracted plural mobile communication services MSj, . . . . Incidentally, the operation of this mobile communication terminal 10i will be described later.

When any one mobile communication terminal (for example, the mobile communication terminal 101) initiates communication after location registration with the database DB1 (a full line L11), however, the other mobile communication terminals can not use the mobile communication terminal MS1 (broken lines L21, L31, . . . , Ln1).

The other mobile communication terminals 102 to 10m attempt communication by means of a service with the second lowest usage fee (for example, the mobile communication service MS2). On this occasion, any one mobile communication terminal (for example, the mobile communication terminal 102) succeeds in communication (a full line L22), and consequently, the other mobile communication terminals 103 to 10m come to use mobile communication services with higher usage fees.

Incidentally, in FIG. 1, a broken line Lxy (x≠y) shows that communication is attempted but ends in failure, and full lines L11, L22, L33, . . . , Lnn show that communication finally succeeds.

Therefore, although there is no guarantee that all mobile communication terminals can use the most inexpensive communication, the degree of satisfaction for each mobile communication terminal user can be maximized by statistically grasping the number of mobile communication terminals which perform communication at the same time and setting contract line numbers so that the cost performance is optimized.

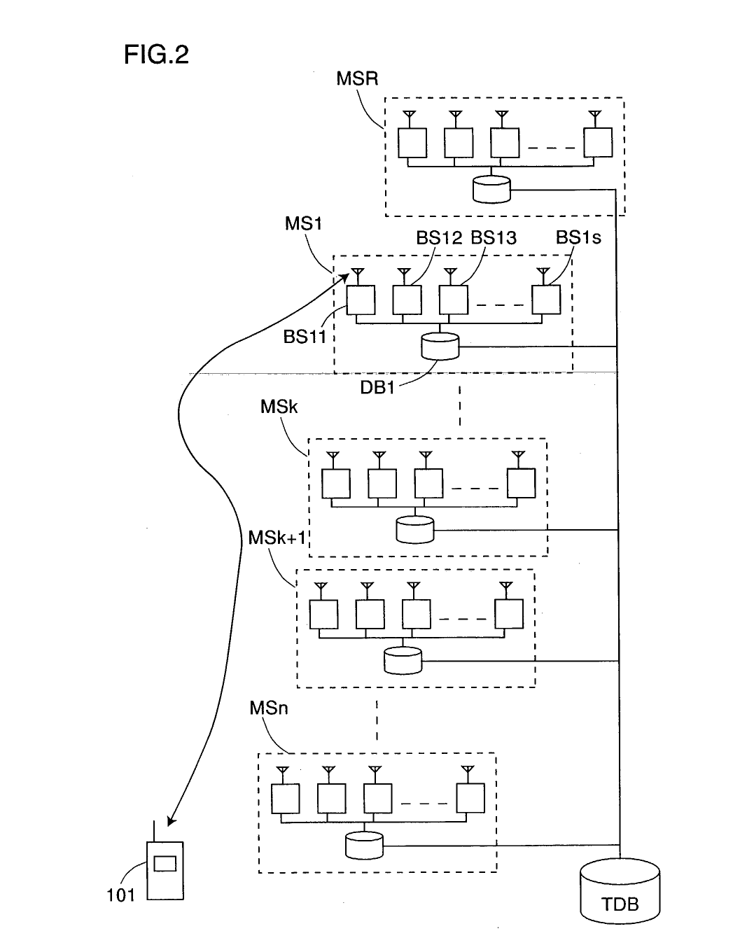

It should be noted that a receive-only mobile communication service may be included in contracted mobile communication services. FIG. 2 is a block diagram showing the configuration of another mobile communication system according to the embodiment 1. In FIG. 2, the receive-only mobile communication service is denoted by a symbol MSR. Until the mobile communication terminal 10i makes an outgoing call, location registration by the mobile communication services MS1 to MSn is not performed, but even in this case, the receive-only mobile communication service MSR performs location registration concerning all of the mobile communication terminals 10i within its service area. Hence, each of the mobile communication terminals 10i within the service area can receive an incoming call certainly.

Next, operation when charges are totaled will be explained.

When getting an outgoing call from any mobile communication terminal 10i (1≦i≦N), each mobile communication service MSj (1≦j≦n) determines whether to allow or to disallow the communication referring to the billing server TDB. Then, the usage fee is registered for a line which the mobile communication terminal 10i, which is allowed the communication, uses in the billing server TDB.

Respective users are billed for line usage fees collectively based on the billing server TDB, whereby the burden of billing management, charging operation, management imposed on each mobile communication service MSj is reduced, which makes it possible to provide a plurality of mobile communication services MSj integratedly and economically.

Moreover, the user makes an integrated contract regarding all of the contracted mobile communication services, and hence can be given a discount service concerning a basic fee or the like as compared with an individual contract.

Next, the mobile communication terminals 101 to 10N used in the aforementioned mobile communication system will be explained. Incidentally, the mobile communication terminal 101 will be explained here, but the other mobile communication terminals 102 to 10N have the same configuration and operate in the same manner.

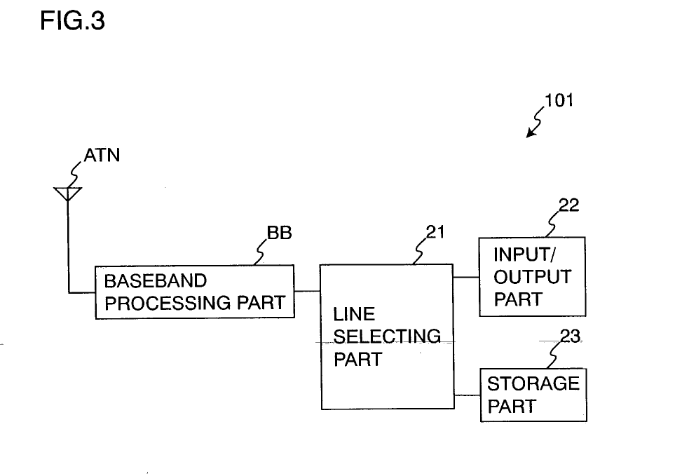

FIG. 3 is a block diagram showing the configuration of the mobile communication terminal 101 in FIG. 1. As shown in FIG. 3, the mobile communication terminal 101 includes a baseband processing part BB connected to an antenna ATN. The baseband processing part BB is connected to a line selecting part 21. An input/output part 22 for inputting/outputting voice and data and a storage part 23 for storing various pieces of information are connected to the line selecting part 21.

The storage part 23 is a circuit or a device such as a semiconductor memory, a record medium, or the like in which information on business areas and communication fees for respective mobile communication lines is stored. In more detail, the storage part 23 stores the following information.

(1) ID Information

This ID information is a unique identification code for specifying the mobile communication terminal 101. Each of the mobile communication services allows or disallows communication and performs billing management based on this ID information.

(2) Information on Line Usage Fees for Respective Mobile Communication Services

(3) A Mobile Communication Line, or a Local or Toll Line of a Fixed Line Corresponding to a Telephone Number of a Receiving Party

(4) The Relation Between the Location of a Mobile Station and a Cell (Base Station) of each Mobile Communication Service MSj (that is, Information on Business Areas)

Moreover, the baseband processing part BB is a circuit which is adaptable to plural mobile communication services with which usage contracts are concluded and non-contracted mobile communication services, and selects a mobile communication service to be used, for example, in terms of software.

Incidentally, it is also possible to provide plural baseband processing parts BB in the mobile communication terminal 101, connect these plural baseband processing parts BB in parallel to the line selecting part 21, and use these baseband processing parts selectively or in parallel. When they are used in parallel, separate communications can be performed simultaneously.

The line selecting part 21 is a circuit for selecting the mobile communication service MSJ with the lowest line usage fee out of the mobile communication services MSJ, . . . usable in a current location. When the mobile communication terminal 101 is outside the coverage of all of the contracted mobile communication services MS1 to MSn, the line selecting part 21 may permit the use of a line by receiving control mandate of a control server of a non-contracted mobile communication service. This control mandate by the control server is possible if Japanese Patent No. 3153213 owned by the present applicant is applied.

Incidentally, in this embodiment 1, the baseband processing part BB functions as a location information acquiring part for acquiring its own current location information based on the contracted mobile communication line or the receive-only mobile communication line, and the line selecting part 21 is a circuit or a device for selecting, based on the information on business areas of and communication fees for the respective mobile communication lines stored in the storage part 23, a mobile communication line which is not used by other mobile communication terminals and is the most inexpensive out of the mobile communication lines whose business areas cover a current location shown by the location information acquiring part.

Moreover, the baseband processing part BB and the line selecting part 21 may be realized by storing a control program in the storage part 23 and executing the control program by a CPU.

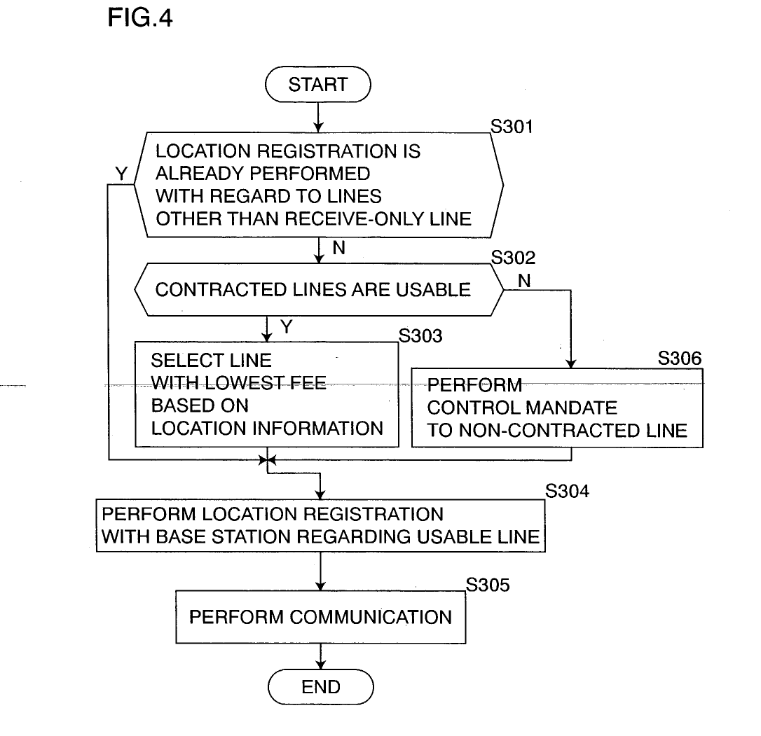

Subsequently, the operation of this mobile communication terminal 101 will be explained. FIG. 4 is a flowchart explaining the operation of this mobile communication terminal 101.

In step S301, the mobile communication terminal 101 first determines whether or not location registration is already performed with regard to lines other than the receive-only line.

When the location registration with regard to the lines other than the receive-only line is not yet performed, in step S302, the mobile communication terminal 101 determines whether contract lines are usable or not, that is, whether it is within the coverage of any contracted mobile communication service MSj or not.

When the contract lines are usable, in step S303, the mobile communication terminal 101 selects a line with the lowest fee out of the contract lines. Consequently, the user can automatically obtain an inexpensive communication service. Namely, after location registration is performed, based on the location information, the line selecting part 21 of the mobile communication terminal 101 selects the mobile communication service MSJ with the lowest line usage fee out of the contracted mobile communication services MSj whose business areas cover a current location.

Incidentally, when the most inexpensive mobile communication service MSJ is selected, it may be selected in consideration of a communication mode (voice communication, packet transmission, or the like) used in the line, a calling telephone number (that is, a telephone number of the other party), and the like. Since information necessary for the selection of a line is held inside the mobile communication terminal 101, selection processing is performed promptly.

Meanwhile, when the contract lines are not usable in step S302, the mobile communication terminal 101 performs control mandate regarding a non-contract line in step S306. In this case, the non-contract line is selected.

In step S304, the mobile communication terminal 101 performs location registration with the base station regarding the usable line to enable communication. Incidentally, when the non-contract line is selected in step S304, location registration is performed with the base station of the non-contract line.

In step S305, the mobile communication terminal 101 performs communication via the selected line, that is, via the selected mobile communication service MS1.

For example, in the plural mobile communication services MSR, MS1, . . . , MSn shown in FIG. 2, when the mobile communication system selected for location specification is MS1, the mobile communication terminal 101 communicates with a base station (for example, BS11) corresponding to a cell, in which the mobile communication terminal 101 itself is included, out of plural base stations BS11, BS12, . . . , BS1s included in the mobile communication service MS1.

It should be noted that if fee information and the like on the non-contract lines is registered at the line selecting part 21, also concerning the non-contract lines, a line with the lowest fee can be extracted.

Furthermore, when being within the service area of the receive-only line, the line selecting part 21 of the mobile communication terminal 101 specifies the current location of this mobile communication terminal 101 by the receive-only line, and on the other hand, when being outside the service area of the receive-only line, the line selecting part 21 searches other contracted mobile communication services MSj whose service areas cover the current location, and specifies the current location of this mobile communication terminal 101 by communication with the base station of the mobile communication service first detected. Instead of the first detected mobile communication service MSj, the mobile communication service MSj best suited to location specification may be adopted.

Incidentally, the baseband processing part BB, the storage part 23, and the line selecting part 21 of each of the mobile communication terminals 101 to ION also function as a line selecting device comprising a communication means (baseband processing part BB) capable of using plural types of communication lines, a storage means (storage part 23) in which information on communication fees for respective communication lines is stored, and a selection means (line selecting part 21) for selecting the most inexpensive communication line according to the intended use of the communication line, based on the information on communication fees stored in the storage means. Consequently, a line with a lower usage fee can be selected.

Embodiment 2.

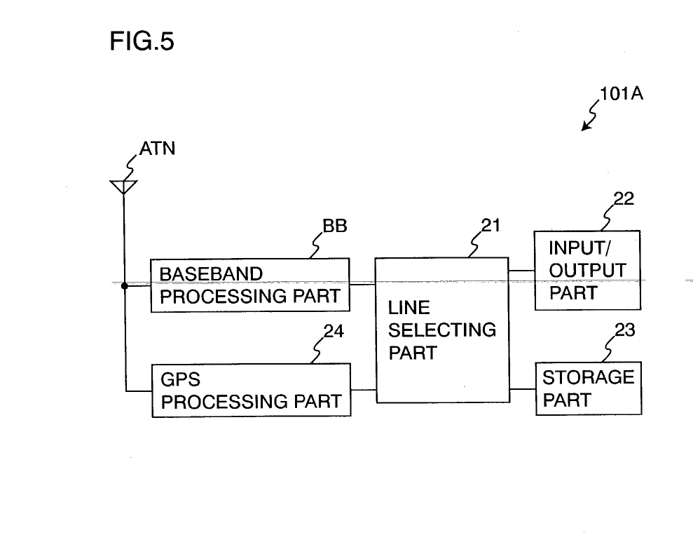

FIG. 5 is a block diagram showing the configuration of a mobile communication terminal 101 according to the embodiment 2 of the present invention. In FIG. 5, the same numerals and symbols are given to portions identical with or equivalent to those shown in FIG. 2, and the explanation thereof is omitted.

The mobile communication terminal 101A, likewise with that in the embodiment 1, comprises the antenna ATN, the baseband processing part BB, the line selecting part 21, the input/output part 22, and the storage part 23. The same information as in the embodiment 1 is stored in the storage part 23.

The mobile communication terminal 101A according to the embodiment 2 further comprises a GPS processing part 24. The GPS processing part 24 is connected to the antenna ATN and the line selecting part 21. The GPS processing part 24 receives a GPS signal from a GPS (Global Positioning System) satellite and specifies the location of this mobile communication terminal 101A. In other words, in this embodiment 2, the GPS processing part 24 functions as a location information acquiring part for acquiring its current location information based on the GPS signal.

The line selecting part 21 in this embodiment 2 selects a mobile communication service with the lowest line usage fee out of contracted mobile communication services, based on the location information obtained by the GPS signal, or the location information and the receive-only mobile communication service.

Incidentally, when the mobile communication terminal 101A is outside the coverage of all of the contracted mobile communication services MSj, the use of a line is made possible by receiving control mandate of a control server of a non-contracted mobile communication service.

As stated above, according to the aforementioned embodiment 2, it is possible to always perform location registration without using the receive-only mobile communication service MSR. Moreover, when the receive-only mobile communication service MSR is used together, the location registration can be performed more certainly.

Embodiment 3.

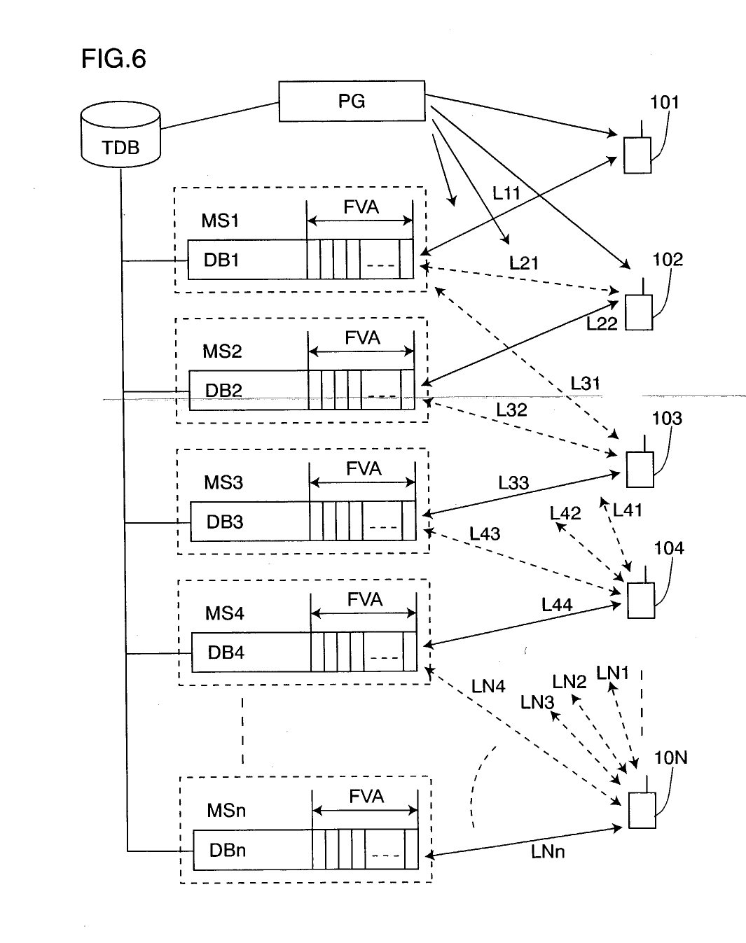

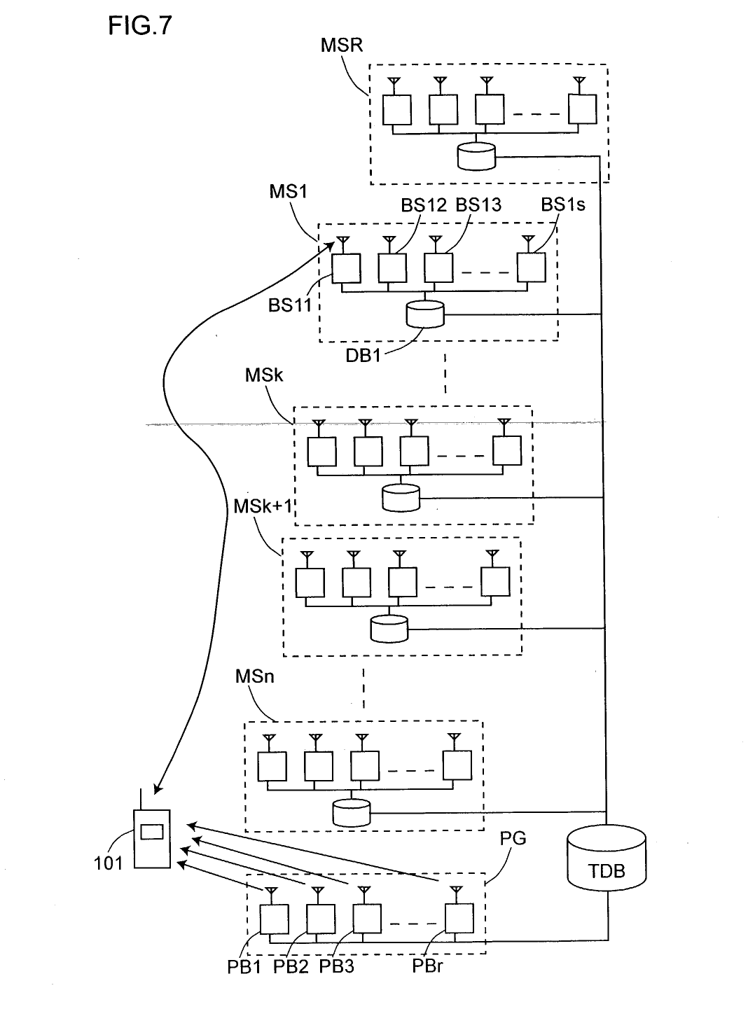

FIG. 6 is a block diagram showing the configuration of a mobile communication system according to the embodiment 3 of the present invention. FIG. 7 is a block diagram showing a communication situation of one mobile communication terminal in the embodiment 3.

As shown in FIG. 6, similarly to the embodiment 1, in the mobile communication system according to this embodiment 3, the plural mobile communication terminals 101, 102, . . . , 10N adapting to the plural mobile communication services MS1, MS2, . . . , MSn are used, and plural common line numbers of one or plural mobile communication services MSj, . . . are assigned to the plural mobile communication terminals 10i, . . . .

Moreover, in this mobile communication system, a pager system PG can be adapted, and a signal concerned with a pager can be sent to the mobile communication terminal 10i (1≦i≦N) by which an incoming call is to be received via a communication line of the pager. On the occasion of reception of the incoming call, a signal to urge location registration can be sent to the mobile communication terminal 10i from the billing server TDB via the communication line of the pager.

In FIG. 7, on the occasion of reception of the incoming call via the pager system PG, the billing server TDB instructs the pager system PG to make an outgoing call to the specific mobile communication terminal 10i. All of base stations PB1 to PBr of the pager system PG call up this specific mobile communication terminal 10i, and hence the location registration of the specific mobile communication terminal 10i can be performed promptly in a broad area, whereby it is possible to receive an incoming call without prior location registration. Accordingly, in this case, a contract with another mobile communication service for receiving an incoming call is not particularly necessary.

As stated above, according to the aforementioned embodiment 3, it is possible to always perform location registration without using the receive-only mobile communication service MSR. Moreover, when the receive-only mobile communication service MSR is used together, the location registration can be performed more certainly.

Further, a receiving device of the mobile communication terminal needs extremely low electric power consumption for the pager system, and hence it is advantageous to long hours of use.

Furthermore, power-saving and inexpensive system can be realized by using the pager system PG for location registration for receiving incoming calls.

Embodiment 4.

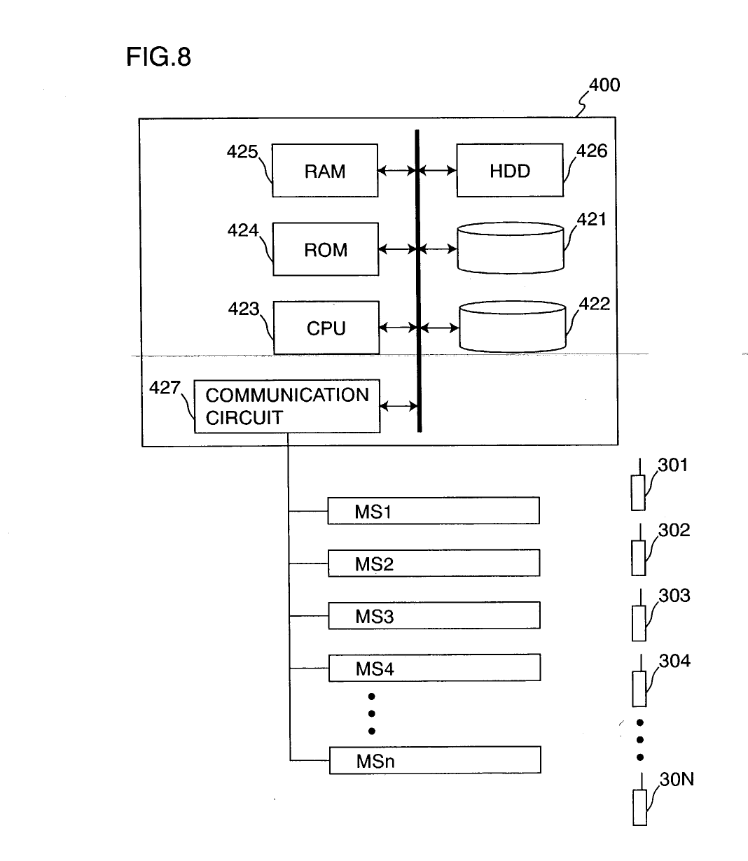

FIG. 8 is a block diagram showing the configuration of a communication system according to the embodiment 4 of the present invention.

In FIG. 8, each of the mobile communication services MS1 to MSn is a kind of communication service for providing communication lines, and similarly to that in the embodiment 1, is a system run by a carrier, for providing mobile communication lines for customers (namely, users), calculating customers' line usage fees according to fee systems contracted by respective customers, and supplying a billing server 400 with information on the respective customers' line usage fees and information on line usage fees it can provide. It should be noted that the information on line usage fees means information on basic fees, usage-basis fees, and so on, and when there are plural fee systems, it includes information on the respective fee systems.

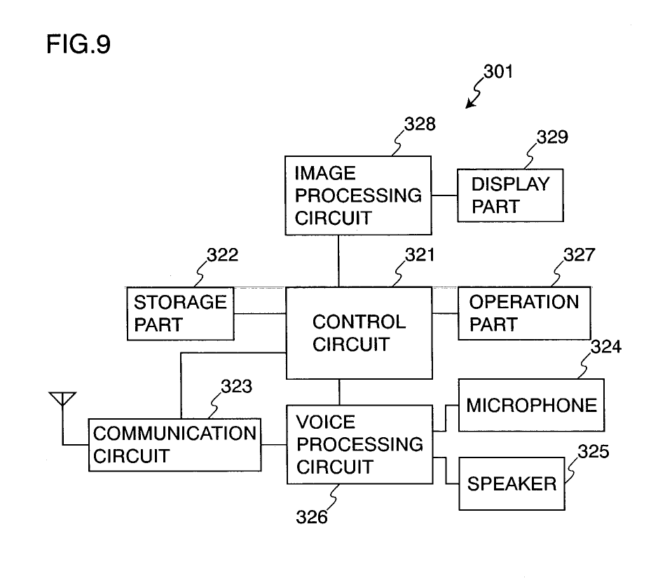

Each of the mobile communication terminals 301 to 30N is a communication terminal capable of using communication lines of plural types of mobile communication services. FIG. 9 is a block diagram showing the configuration of the communication terminal 301 in FIG. 8. The mobile communication terminals 302 to 30N also have the same structure.

In FIG. 9, a control circuit 321 is a circuit for performing various types of processing and controlling respective parts. Incidentally, this control circuit 321 performs various types of processing in response to user operation to an operation part 327 to execute packet transmission by controlling a communication circuit 323 and make a display part 329 display various types of information by controlling an image processing circuit 328. Moreover, with this control circuit 321 being a CPU, the aforementioned operation may be performed in accordance with a control program not shown but stored in a storage part 322.

Furthermore, this control circuit 321 functions as a selection means for selecting the most inexpensive communication line according to the intended use of the communication line, based on the information on communication fees stored in the storage part 322.

The storage part 322 is a storage means such as a semiconductor memory, a magnetic record medium, or an optical record medium for storing information on communication fees for communication lines provided by respective mobile communication services. When the control circuit 321 is a CPU, the storage part 322 further stores various types of control programs.

The communication circuit 323 is a communication means capable of using various types of communication lines provided by plural mobile communication services.

A microphone 324 is a device for sensing user's voice and converting it into electric signals.

A speaker 325 is a device for converting voice signals into voice.

A voice processing circuit 326 is a circuit for converting analog voice signals from the microphone 324 into voice data, converting voice data into voice signals, and supplying the voice signals after conversion to the speaker 325.

The operation part 327 is one or plural electronic components such as dedicated keys, buttons, and dial keys corresponding to various types of processing for converting operation by the user into changes in electric signal.

The image processing circuit 328 is a circuit for supplying the display part 329 with image signals corresponding to data supplied from the control circuit 321 and making it display an image corresponding to the data.

The display part 329 is a display device such as a liquid crystal display for displaying various types of information.

Returning to FIG. 8, the billing server 400 is not only a server for classifying information on respective customers' line usage fees sent from respective mobile communication services by each customer and calculating the total of usage fees for various types of lines used by each customer in the same manner as the billing server TDB in the embodiment 1, but also a server for sending individual fee data having fee systems of all communication services contracted by the customer who is a user of the mobile communication terminal 30i to the mobile communication terminal 30i of each customer.

In the billing server 400, a database 421 is a first storage means for storing information indicating types of respective communication services used by each of users as customers. In this database 421, in addition to this information, data on usage fees for lines actually used by each user, and the like are recorded.

Moreover, a database 422 is a second storage means for storing fee information on plural communication services.

A CPU 423 is a device for performing various types of processing in accordance with programs stored in a ROM 424, a RAM 425, and an HDD 426.

The ROM 424 is a memory which previously stores data and a program used at the time of starting and other data and programs. The RAM 425 is a memory which, at the time of execution of a program, temporarily stores the program and data. The HDD 426 is a hard disk device which stores an operating system, application programs in which various types of processing are described and various types of data.

A communication circuit 427 is a circuit for executing data communication with respective communication services MSj.

Incidentally, in this embodiment 4, by executing a predetermined program by the CPU 423, an individual fee data generating means for unifying fee information on one or plural communication services MSj used by each user based on information indicating types of the respective communication services MSj used by each user and fee information on the respective communication services MSj to generate individual fee data with respect to each user is realized.

Moreover, the communication circuit 427 functions as a sending means for sending individual fee data for their respective users as information on communication fees to the mobile communication terminals 301 to 30N of users and also as a receiving means for receiving fee information sent from the plural communication services MS1 to MSn.

Next, the operation of the aforementioned communication system will be explained.

The totaling of charges of each user is the same as in the case of the embodiment 1, and hence the explanation thereof is omitted.

Next, the operation of the aforementioned communication system on line selection will be explained.

Each mobile communication service MSj (1≦j≦n) sends fee information on communication lines provided by the mobile communication service itself to the billing server 400. For example, when newly generating fee information or updating fee information, each mobile communication service MSj sends the information to the billing server 400. Incidentally, when a new mobile communication service MSn+1 joins, the mobile communication service MSn+1 also sends fee information to the billing server 400. When the mobile communication service MSj provides plural fee systems, information on all these fee systems is included in the fee information.

Upon reception of the fee information from each mobile communication service MSj, the billing server 400 registers the fee information on the mobile communication service MSj with the database 422 if the fee information on the mobile communication service MSj is new, and if the fee information on the mobile communication service MSj is already registered, the fee information registered at the database 422 is updated with the received fee information.

On this occasion, in the billing server 400, the communication circuit 427 receives the fee information, and the CPU 423 transfers the fee information to the database 422 and makes it store the fee information in accordance with a program.

When the registration of new fee information or the updating of fee information occurs as stated above, the billing server 400 searches the database 421 to specify the mobile communication services MSj, . . . used by each of users, searches fee information registered at the database 422 concerning the specified mobile communication services MSj, . . . , and extracts and unifies the fee information on the communication services MSj, . . . used by each user to generate individual fee data.

On this occasion, in the billing server 400, for example, the CPU 423 searches the database 421 and the database 422 in accordance with a program and makes the RAM 425 or the HDD 426 temporarily store the extracted fee information to generate individual fee data. The generated individual fee data is stored in the database 421 in association with respective customers.

The billing server 400 then sends the generated individual fee data on each user to the mobile communication terminal 30i of the user. On this occasion, the CPU 423 makes the communication circuit 427 send the individual fee data by controlling it in accordance with the program. Any of the communication services MSj, . . . contracted by the user is used for the transmission of the individual fee data. The billing server 400 may not perform generation and sending of the individual fee data for users whose individual fee data remains unchanged.

If the individual fee data is sent, the mobile communication terminal 30i (1≦i≦N) receives it and stores it in the storage part 322. When individual fee data is already stored, the mobile communication terminal 30i updates the stored individual fee data with the received one. On this occasion, the control circuit 321 makes the storage part 322 store the individual fee data received by the communication circuit 323.

Thereafter, the mobile communication terminal 30i (1≦i≦N) refers to this individual fee data when initiating communication in accordance with operation by the user or automatically, compares fees for the respective mobile communication services MSj registered at the individual fee data in consideration of information on a communication mode to be used (voice communication, packet transmission, and others), and selects a communication line with the lowest line usage fee. When communication lines of plural mobile communication terminals 30i, . . . compete with each other on this occasion, the assignment of lines is performed in the same manner as in the embodiment 1.

It should be noted that the most inexpensive communication line according to the communication mode and the type of the other party's communication device (which carrier the other party's communication device belongs to, in this embodiment 4) may be selected. Besides, the communication line with the lowest line usage fee may be selected in consideration of information on a present time obtained referring to a built-in timer not shown and the like.

Upon selection of a communication line to be used, the mobile communication terminal 30i (1≦i≦N) initiates communication via the communication line. On this occasion, the control circuit 321 makes the communication circuit 323 establish the communication line by controlling it.

When the individual fee data is changed during communication after the communication line is already established, the mobile communication terminal 30i may select again a communication line with the lowest line usage fee based on the changed individual fee data and switch the communication line being used at that moment into the selected communication line.

Furthermore, when the communication line is already established, the mobile communication terminal 30i may switch the communication line being used for communication into another communication line according to a communication information amount. In this case, the control circuit 321 functions as a line switching means.

On this occasion, when it is possible to estimate, based on operation by the user, for example, an instruction to download image data on Internet or the like, the communication information amount occurred as the result of the operation, the communication information amount may be estimated from the operation. In this case, the control circuit 321 functions as a communication information amount estimating means for estimating, depending on operation by the user, the communication information amount occurred as the result of the operation.

Incidentally, the communication circuit 323, the storage part 322, and the control circuit 321 of each of the mobile communication terminals 301 to 30N also function as a line selecting device comprising a communication means (communication circuit 323) capable of using plural types of communication lines, a storage means (storage part 322) in which information on communication fees for respective communication lines is stored, and a selection means (control circuit 321) for selecting the most inexpensive communication line according to the intended use of the communication line, based on the information on communication fees stored in the storage means.

As stated above, according to the aforementioned embodiment 4, the billing server 400 extracts fee information on the communication services MSj, . . . used by each of users from fee information on the plural mobile communication services MS1 to MSn and unifies it to generate individual fee data, and sends the generated individual fee data to the mobile communication terminal 30i of the user, and the mobile communication terminal 30i of the user receives the individual fee data. Based on the received individual fee data, the mobile communication terminal 30i of the user selects the most inexpensive communication line according to a communication mode to be used. Hence, a line with a lower usage fee can be selected.

Moreover, according to the aforementioned embodiment 4, each of the mobile communication terminals 301 to 30N comprises the communication circuit 323 capable of using plural types of communication lines, the storage part 322 in which information on communication fees for respective communication lines is stored, and the control circuit 321 for selecting the most inexpensive communication line according to the intended use of the communication line, based on the information on communication fees stored in the storage part 322. Thereby, each of the mobile communication terminals 301 to 30N can automatically select a line with a lower usage fee.

Further, according to the aforementioned embodiment 4, the control circuit 321 selects the most inexpensive communication line according to the communication mode and the type of the other party's communication device based on the information on communication fees stored in the storage part 322, whereby, even when used communication modes mingle, a line with a lower usage fee can be selected according to each of the communication modes.

Furthermore, according to the aforementioned embodiment 4, the control circuit 321 functions as an individual fee data receiving means for receiving information on communication fees for the user of the mobile communication terminal 30i, that is, individual fee data sent from the billing server 400 which manages information on users of the mobile communication terminals 30i, and the storage part 322 stores the received individual fee data. As a result, at the time of initial use and when a change is made in or an addition is made to fee information on the mobile communication service MSj, the individual fee data stored in the mobile communication terminal 30i is immediately stored or modified, whereby a line with a lower usage fee can be always selected.

Besides, according to the aforementioned embodiment 4, when a communication line is already established, the control circuit 321 switches the communication line being used for communication into another communication line according to the communication information amount, whereby even during communication, a more inexpensive line is used, resulting in a further reduction in line usage fee.

Moreover, according to the aforementioned embodiment 4, the control circuit 321 estimates, depending on operation by the user, the communication information amount occurred as the result of the operation, whereby it is possible to switch the communication line into a communication line consistent with the communication information amount, resulting in a further reduction in line usage fee.

Further, according to the aforementioned embodiment 4, with respect to each of users, the billing server 400 comprises the database 421 for storing information indicating types of respective communication services used by each of the users, the database 422 for storing fee information on the plural communication services MS1 to MSn, the CPU 423 for executing a program for unifying fee information on one or plural communication services MSj, . . . used by each of the users and generating individual fee data based on the information indicating the types of the respective communication services MSj, . . . used by each of the users and fee information on each communication service MSj, and the communication circuit 427 for sending the individual fee data for a user to the mobile communication terminal 30i of the user. Therefore, the individual fee data generated for each of the users based on fee information on respective communication services is delivered to the mobile communication terminal 30i of the user, whereby a line with a lower usage fee can be selected.

Furthermore, according to the aforementioned embodiment 4, the database 421 functions as a third storage means for storing information indicating the types of fee systems contracted by the user concerning respective communication services used by the user, and the CPU 423 for executing a program which functions as the individual fee data generating means refers to fee information from each communication service MSj, and unifies fee information on fee systems contracted by the user with regard to one or plural communication services MSj, . . . used by the user to generate individual fee data for each user. Consequently, the communication terminal can select a line with a lower usage fee in consideration of the fee systems contracted by the user.

In addition, according to the aforementioned embodiment 4, since the communication circuit 427 receives fee information on the plural communication services MS1 to MSn, the individual fee data can be generated based on the fee information sent from the communication services, and the fee information on the communication services can be reflected in the individual fee data correctly and promptly.

Embodiment 5.

A communication system according to the embodiment 5 of the present invention is a system in which a user subscribes to one or more than one communication service out of communication services C1 to Cn which provides communication lines via physical communication infrastructures 501 to 50L such as a general phone line and the like, and in which the lines provided by the communication services Ci can be used by a communication terminal of the user.

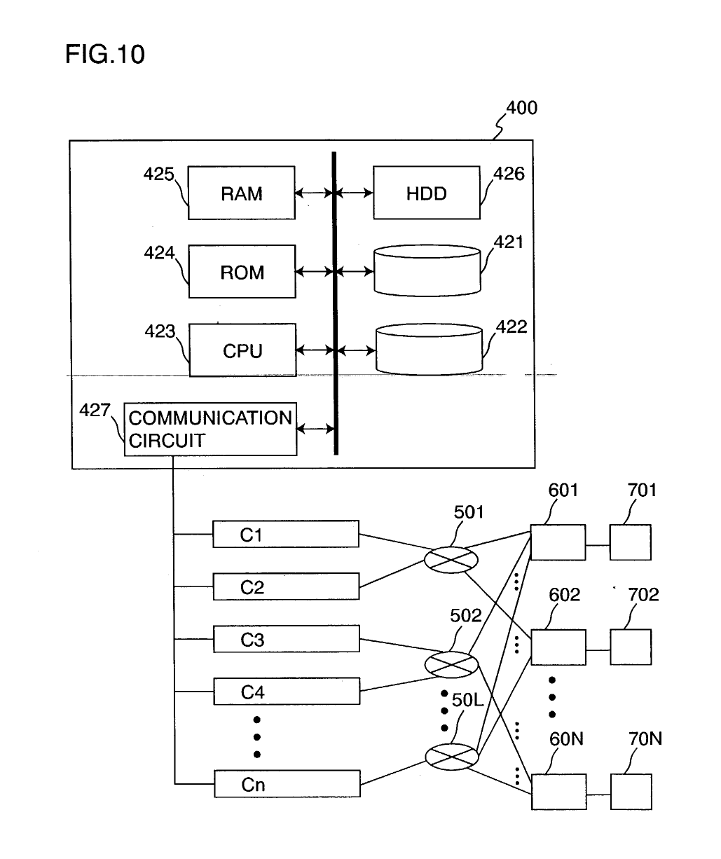

FIG. 10 is a block diagram showing the configuration of a communication system according to the embodiment 5 of the present invention. In FIG. 10, the communication services C1 to Cn are communication services which provide general analog phone lines, ISDN (Integrated Services Digital Network) lines, and ADSL (Asymmetric Digital Subscriber Line) lines of respective carriers, communication lines by a cable television carrier, and so on.

The communication infrastructures 501 to 50N are communication infrastructures including physical communication networks such as a telephone network and a cable television network, and mobile communication networks.

Line selecting devices 601 to 60N are devices, connected to one or plural communication infrastructures 50k, . . . , for selecting any one of lines of the plural communication services Ci obtainable via the communication infrastructures 50k.

Fixed telephones 701 to 70N are telephones for executing phone calls via general analog phone lines and ISDN lines.

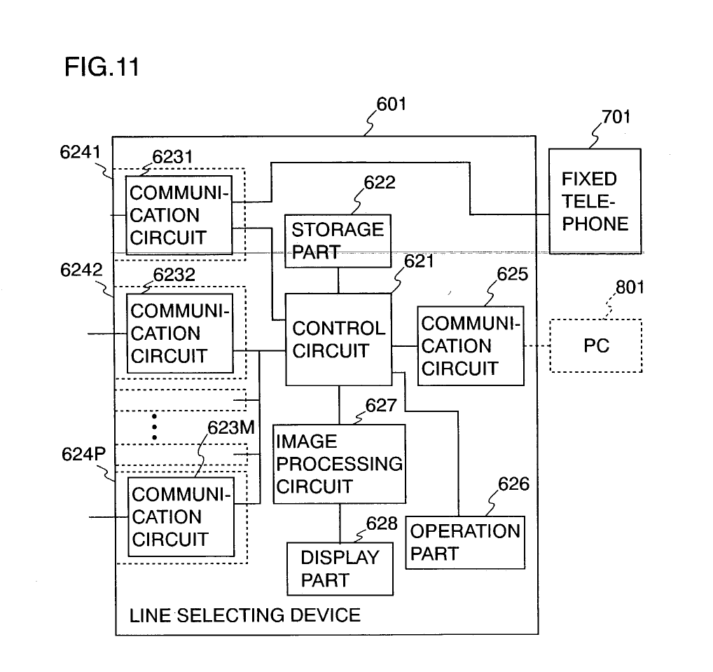

In addition to the fixed telephone 70i, one or plural personal computers 801 or the like can be connected to the line selecting device 60i as shown in FIG. 11.

It should be noted that the other components in FIG. 10 are the same as those in the embodiment 4, and hence the explanation thereof is omitted.

FIG. 11 is a block diagram showing the configuration of the line selecting device 601 in FIG. 10. In FIG. 11, a control circuit 621 is a circuit which functions as a selection means for selecting the most inexpensive communication line according to the intended use of the communication line based on information on communication fees stored in a storage part 622. Moreover, with this control circuit 621 being a CPU, the aforementioned operation may be performed in accordance with a control program not shown but stored in the storage part 622.

The storage part 622 is a storage means such as a semiconductor memory, a magnetic record medium, or an optical record medium for storing information on communication fees for communication lines provided by respective communication services Cj. When the control circuit 621 is a CPU, the storage part 622 further stores various types of control programs.

Communication circuits 6231 to 623M are a communication means capable of using various types of communication lines provided by plural communication services C1 to Cn.

Out of these, the communication circuit 6231 is a circuit which is connected to an analog telephone network as the communication infrastructure 50k, establishes an analog phone line, and is connected to the fixed telephone 701. The other communication circuits 623m are connected to the other communication infrastructures 50k, respectively.

It is possible that part of or all of the communication circuits 6231 to 623M are incorporated in advance as internal circuits, and also that a predetermined number P of slots 6241 to 624P are provided in the line selecting device 601, the communication circuits 623m (m=1 to M) are constructed as independent and insertable and extractable modules, and the communication circuit 623m is electrically connected to the control circuit 621 or the like at the time of insertion of the module.

A communication circuit 625 is an interface circuit such as a serial interface or a network interface such as Ethernet™, for performing communication with one or plural personal computers 801. Any of circuits based on other communication standards such as wireless LAN, infrared communication, and Bluetooth may be adopted as the communication circuit 625, and a plurality of circuits based on such standards may be provided.

An operation part 626 is one or more than one electronic component which is operated by the user and supplies a signal in response to the operation to the control circuit 621.

An image processing circuit 627 is a circuit for converting digital image data to image signals.

A display part 628 is one or more than one device for displaying an image such as a text, a graphic, or the like based on the image signals from the image processing circuit 627.

Next, the operation of the aforementioned communication system will be explained.

The totaling of charges of each user is the same as in the case of the embodiment 1, and hence the explanation thereof is omitted.

Firstly, the operation of the aforementioned communication system on line selection will be explained.

Each communication service Cj (1≦j≦n) sends fee information on communication lines provided by the mobile communication service itself to the billing server 400. For example, when newly generating fee information or updating fee information, each communication service Cj sends the information to the billing server 400. When a new communication service Cn+1 joins, the communication service Cn+1 also sends fee information to the billing server 400. When the communication service Cj provides plural fee systems, information on all these fee systems is included in the fee information.

The billing server 400 operates in the same manner as in the embodiment 4, and when there is a change in fee information on each communication service Cj, it generates individual fee data on related users and sends it to the line selecting device 60i of each of the users.

If the individual fee data is sent, the line selecting device 60i (1≦i≦N) receives it and stores it in the storage part 622. When individual fee data is already stored, the line selecting device 60i updates the stored individual fee data with the received one.

On this occasion, in the line selecting device 60i, the control circuit 621 makes the storage part 622 store the individual fee data received by any communication circuit 623m.

Thereafter, when initiating communication in accordance with a command from the fixed telephone 701 or the personal computer 801, the line selecting device 60i (1≦i≦N) refers to this individual fee data, compares fees for the respective mobile communication services Cj registered at the individual fee data in consideration of information on a communication mode to be used (voice communication, packet transmission, or the like), and selects a communication line with the lowest line usage fee.

It should be noted that the most inexpensive communication line according to the communication mode and the type of the other party's communication device (a modem or the like of Internet provider, a telephone, a facsimile transceiver or the like, in this embodiment 5) may be selected. Besides, the communication line with the lowest line usage fee may be selected in consideration of information on a present time obtained referring to a built-in timer not shown.

Upon selection of a communication line to be used, the line selecting device 60i (1≦i≦N) establishes the communication line and enables communication by means of the fixed telephone 701 and the personal computer 801. On this occasion, the control circuit 621 controls the communication circuit 623m corresponding to the selected communication line so that the communication line is established.

When the individual fee data is changed during communication after the communication line is already established, the line selecting device 60i may select again a communication line with the lowest line usage fee based on the changed individual fee data and switch the communication line being used at that moment into the selected communication line.

Furthermore, while being in communication after the communication line is already established, the line selecting device 60i may switch the communication line being used for the communication into another communication line according to the communication information amount. In this case, the control circuit 621 functions as a line switching means.

On this occasion, if it is possible to estimate the communication information amount occurred as the result of the operation based on a protocol used for communication by the personal computer 801, or the like, the communication information amount may be estimated from the type of the protocol.

In the embodiment 5, although the line selecting devices 601 to 60N are provided in addition to the fixed telephones 701 to 70N and the personal computer 801, the line selecting devices 601 to 60N may be embedded in the fixed telephones 701 to 70N and the personal computer 801. In this case, it is recommended to embed a control means such as a CPU which operates in accordance with a control program and operate the embedded line selecting devices by the control means.

Moreover, if it is possible to estimate the communication information amount occurred as the result of the operation based on operation by the user, for example, an instruction to download image data on Internet or the like, then the communication information amount may be estimated from the operation. In this case, the control circuit 621 functions as a communication information amount estimating means for estimating, depending on operation by the user, the communication information amount occurred as the result of the operation.

As stated above, according to the aforementioned embodiment 5, the billing server 400 extracts fee information on the communication services Cj, . . . used by each of the users from fee information on the plural communication services Cl to Cn, unifies it to generate individual fee data, and sends the generated individual fee data to the communication terminal such as the line selecting device 60i of the user, and the line selecting device 60i of the user receives the individual fee data. Based on the received individual fee data, the line selecting device 60i of the user selects the most inexpensive communication line according to a communication mode to be used. Hence, a line with a lower usage fee can be selected.

Moreover, according to the aforementioned embodiment 5, each of the line selecting devices 601 to 60N comprises the communication circuits 6231 to 623M capable of using plural types of communication lines, the storage part 622 in which information on communication fees for respective communication lines is stored, and the control circuit 621 for selecting the most inexpensive communication line according to the communication mode to be used, based on the information on communication fees stored in the storage part 622. Thereby, a line with a lower usage fee can be automatically selected by each of the line selecting devices 601 to 60N.

Further, according to the aforementioned embodiment 5, the control circuit 621 selects the most inexpensive communication line according to the communication mode and the type of the other party's communication device based on the information on communication fees stored in the storage part 622, whereby, even when used communication modes mingle, a line with a lower usage fee can be selected according to each of the communication modes.

Furthermore, according to the aforementioned embodiment 5, the control circuit 621 functions as an individual fee data receiving means for receiving information on communication fees for the user of the line selecting device 60i (namely, individual fee data) sent from the billing server 400 which manages information on users of the line selecting devices 60i, and the storage part 322 stores the received individual fee data or updates already stored individual fee data with the received individual fee data. As a result, at the time of initial use and when a change is made in or an addition is made to fee information on the communication service Cj, the individual fee data stored in the line selecting device 60i is immediately stored or modified, whereby a line with a lower usage fee can be always selected.

Besides, according to the aforementioned embodiment 5, when a communication line is already established, the control circuit 621 switches the communication line being used for communication into another communication line according to the communication information amount, whereby even during communication, a more inexpensive line is used, resulting in a further reduction in line usage fee.

Moreover, according to the aforementioned embodiment 5, the control circuit 621 estimates, depending on operation by the user, the communication information amount occurred as the result of the operation, whereby it can switch the communication line into a communication line consistent with the communication information amount, resulting in a further reduction in line usage fee.

Incidentally, when the mobile communication terminals 101 to 10N and 101A, the mobile communication terminals 301 to 30N, and the line selecting devices 601 to 60N are operated in accordance with a control program in the aforementioned embodiments 1 to 5, it is also possible to download the control program via various types of communication lines, store it in these devices, and use it.

Moreover, it is also possible to provide a communication system in which the mobile communication service MSj, and the communication service Ci and the communication infrastructure 50i in the aforementioned embodiments 4 and 5 mingle.

### INDUSTRIAL AVAILABILITY

According to the present invention, a line with a lower usage fee can be selected by a communication terminal.

1. A mobile communication terminal to which a plurality of mobile communication lines are assigned, comprising:
a storage part in which information on business areas of and communication fees for respective mobile communication lines is stored;
a location information acquiring part for acquiring its own current location information; and
a line selecting part for selecting the most inexpensive mobile communication line out of mobile communication lines whose business areas cover a current location shown by said location information acquiring part, based on the information on business areas of and communication fees for the respective mobile communication lines stored in said storage part.

2. The mobile communication terminal according to claim 1,
wherein a receive-only mobile communication line is further assigned thereto, and
wherein said location information acquiring part acquires its own current location information, based on the receive-only mobile communication line.

3. The mobile communication terminal according to claim 1,
wherein said location information acquiring part acquires its own current location information based on a GPS signal.

4. The mobile communication terminal according to claim 1,
wherein a communication line of a pager is further assigned thereto, and
wherein said location information acquiring part acquires its own current location information based on the communication line of the pager.

5. The mobile communication terminal according to claim 1, further comprising:
a plurality of baseband processing parts for performing separate communications in parallel.

6. A line selecting device, comprising:
a communication means capable of using plural types of communication lines;
a storage means in which information on communication fees for respective communication lines is stored; and
a selection means for selecting the most inexpensive communication line according to a communication mode to be used, based on the information on communication fees stored in said storage means.

7. The line selecting device according to claim 6,
wherein said selection means selects the most inexpensive communication line according to the communication mode to be used and the type of the other party's communication device, based on the information on communication fees stored in said storage means.

8. The line selecting device according to claim 6, further comprising:
an individual fee data receiving means for receiving the information on communication fees for a user of this line selecting device sent from a billing server which manages information on users of line selecting devices,
wherein said storage means stores the information on communication fees received by said individual fee data receiving means.

9. The line selecting device according to claim 6, further comprising:
a line switching means for, when a communication line is already established, switching the communication line being used for communication to another communication line according to a communication information amount.

10. The line selecting device according to claim 9, further comprising:
a communication information amount estimating means for estimating, depending on operation by a user, the communication information amount occurred as the result of the operation.

11. A communication terminal, comprising:
a communication means capable of using plural types of communication lines;
a storage means in which information on communication fees for respective communication lines is stored;
a selection means for selecting the most inexpensive communication line according to a communication mode to be used, based on the information on communication fees stored in said storage means; and
a control means for, at the start of communication, controlling said selection means so that a communication line is selected and controlling said communication means so that the communication line is selectively established.

12. A billing server, comprising:
a first storage means for storing information indicating types of respective communication services used by each of users with respect to each user;
a second storage means for storing fee information on a plurality of communication services;
an individual fee data generating means for unifying fee information on one or plural communication services used by each of the users to generate individual fee data with respect to each user, based on the information indicating the types of the respective communication services used by each of the users and the fee information on the respective communication services; and
a sending means for sending the individual fee data for the user to a communication terminal of the user.

13. The billing server according to claim 12, further comprising:
a third storage means for storing information indicating types of fee systems contracted by the users regarding the respective communication services used by the users,
wherein said individual fee data generating means for referring to fee information from the respective communication services and regarding one or plural communication services used by each of the users, and for unifying fee information on the fee systems contracted by the user concerning the respective communication services to generate the individual fee data with respect to each user.

14. The billing server according to claim 12, further comprising:
a receiving means for receiving the fee information on the plurality of communication services.

15. A mobile communication system for providing a plurality of communication services, comprising:
a mobile communication terminal which is allowed to obtain the plurality of mobile communication services and sends an identification code unique to itself when making an outgoing call;
a plurality of control servers which are provided for the plurality of mobile communication services, when said mobile communication terminal makes the outgoing call, acquires the unique identification code for specifying said mobile communication terminal, and stores billing information on said mobile communication terminal in association with the identification code; and
a billing server which classifies the billing information stored in all of said control servers by each mobile communication terminal based on the identification code and generates billing information on each user.

16. The mobile communication system according to claim 15,
wherein said mobile communication terminal performs location registration by a receive-only mobile communication line and receives an incoming call by this receive-only mobile communication line by which the location information is performed.

17. The mobile communication system according to claim 15,
wherein said mobile communication terminal performs location registration based on a GPS signal.

18. The mobile communication system according to claim 15,
wherein said mobile communication terminal is adaptable to a communication line of a pager, and
wherein said billing server sends a signal for allowing location registration to be performed to said mobile communication terminal via the communication line of the pager.

19. A communication system, comprising:
a communication terminal including a communication means capable of using plural types of communication lines, a storage means in which information on communication fees for respective communication lines is stored, and a selection means for selecting the most inexpensive communication line according to a communication mode to be used, based on the information on communication fees stored in the storage means; and
a billing server including a first storage means for storing information indicating types of respective communication services used by each of users with respect to each user, a second storage means for storing fee information on a plurality of communication services, an individual fee data generating means for unifying fee information on one or plural communication services used by each of the users to generate individual fee data with respect to each user, based on the information indicating the types of the respective communication services used by each of the users and the fee information on the respective communication services, and a sending means for sending the individual fee data for the user as the information on communication fees to a communication terminal of the user.

20. A line selecting method, comprising the steps of:
extracting fee information on communication services used by each of users from fee information on a plurality of communication services and unifying it to generate individual fee data;
sending the generated individual fee data to a communication terminal of the user;
receiving the individual fee data by the communication terminal of the user; and
selecting the most inexpensive communication line according to a communication mode to be used, based on the received individual fee data by the communication terminal of the user.

21. A control program embodied on a record medium or a carrier wave, for making a mobile communication terminal function as:
a location information acquiring part for acquiring its own current location information; and
a line selecting part for selecting, based on information on business areas of and communication fees for respective mobile communication lines, a mobile communication line which is not used by the other mobile communication terminals and is the most inexpensive out of mobile communication lines whose business areas cover a current location shown by the location information acquiring part.

22. A control program embodied on record medium or a carrier wave, for making electronic equipment function as:
a communication means capable of using plural types of communication lines;
a storage means in which information on communication fees for respective communication lines is stored; and
a selection means for selecting the most inexpensive communication line according to a communication mode to be used, based on the information on communication fees stored in the storage means.
